(19) United States
(12) Patent Application Publication
(10) Pub. No.: US 2010/0131694 A1
(43) Pub. Date: May 27, 2010

(54) Secure Boot ROM Emulation

(76) Inventors: Scott G. Kelly, Santa Clara, CA (US); Shekhar Kshirsagar, San Jose, CA (US); Giridhara S. Gopalan, Los Gatos, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/324,651

(22) Filed: Nov. 26, 2008

(51) Int. Cl. G06F 12/00; G06F 13/00

(52) U.S. Cl. 711/102; 711/E12.001; 711/E12.091

(57) ABSTRACT

Secure boot ROM emulation with locking storage device. A locking storage device is provided by combining a nonvolatile memory device such as flash or EEPROM with one-shot locking logic which write enables at least a portion of the nonvolatile memory device upon power cycling of the overall digital device. This write enable is cleared during the stage 1 bootloader process, thus providing a protected update interval for updating a stage 2 bootloader once per power cycle.

### BACKGROUND OF THE INVENTION

The present invention relates to the startup of digital computing devices, and more particularly to the secure startup of digital computing devices.

Digital computing devices, including desktop or laptop computers, servers, and various types of network appliances and embedded devices, are significantly more reliable from an operational and/or a security standpoint if the integrity of the system software can be validated as part of the system initialization process. Otherwise, the potential exists for this software to be corrupted through system errors or malicious behavior, and such corruption may lead to various forms of undesirable behavior. The burden of providing compatibility, particularly for older protocols and clients, falls upon the wireless system, and in particular on its access nodes. A single access node may be called upon to serve many different types and speeds of clients at the same time.

This problem has been addressed in the past by implementing some sort of software image integrity check which occurs prior to loading and executing the software. Common approaches include computing a CRC-32 checksum over the software image, somehow locally storing that checksum, and then verifying the checksum against a newly computed checksum each time the software is loaded. Due to weaknesses in the CRC approach, variations using some more robust alternative function (e.g. a cryptographic hash function such as MD5 or SHA1, and/or digital signatures) are frequently used.

One difficulty with such mechanisms is that they depend on a leap of faith regarding the integrity of the initial program loader (also called a “bootloader”), which is responsible for validating and loading the system software. If the bootloader is corrupted (or worse, replaced with malicious code), then the mechanism is unreliable, and the leap of faith is unjustified. In general, this is accepted as a limitation which can only be addressed by placing the bootloader in Read Only Memory (ROM).

One drawback of implementing the bootloader in ROM is that, in general, it cannot be easily modified once the system is assembled. The only way to update such bootloaders is to replace the ROM element, which is typically soldered to the circuit board. This limitation may be acceptable for a simple device which is not subject to change, or for which it is acceptable to require the owner to simply purchase a new, updated version whenever additional or new functionality be desired. But for more expensive, dynamic, and long-lived devices, this is far less desirable.

What is needed is a system and method for allowing a bootloader to be updated or replaced in a secure manner.

### BRIEF DESCRIPTION OF THE DRAWINGS

The invention may be best understood by referring to the following description and accompanying drawings that are used to illustrate embodiments of the invention in which:

FIG. 1 shows a target device, and

FIG. 2 shows a diagram of bootloader storage.

### DEFINITIONS

In describing embodiments of the invention, the following Definitions are used:

Target Device: the digital computing device for which the bootloader is intended.

Bootloader: a special program whose purpose is to load the operating system image into RAM and transfer control to the loaded image.

Multi-stage bootloader: a group of programs collectively implementing the loading function by running sequentially, with stage 1 loading stage 2, stage 2 loading stage 3, and so on. Typically, multi-stage loaders are limited to 2 or 3 stages.

Bootloader storage: the storage device on/in which the bootloader resides. Note that this is typically some form of flash memory, but may include other storage technologies. Examples include Solid State Drive (SSD), and Electrically Erasable Programmable ROM (EEPROM).

First (bootloader) stage: the initial stage of the bootloader which is responsible for selecting and loading the second stage.

Second (bootloader) stage: the stage responsible for loading the operating system into RAM and transferring control to it.

Image validation: describes the method used to ensure image integrity and authorization.

Bank select configuration—a stored value indicating which stage 2 “bank” is active.

Verification key: a cryptographic key used in the validation algorithm.

Verification chain: a chain of one or more verification keys leading to a root of trust.

Root of trust: the root in a trust hierarchy, typically the public key of a root Certification Authority (CA), but a single, trusted verification key may be simultaneously considered to be a verification chain (with one link) and a root of trust.

Locking storage device: flash memory, solid state drive, EEPROM, or other non-volatile storage device which provides an electronic locking capability, usually via adjustment of one of the device input signals. This locking capability disallows writing to one or more portions or to the entirety of the storage device.

One-shot locking logic: a logic circuit which can be triggered exactly once per power cycle; resetting this signal requires removing and re-applying power.

One-shot storage lock: a combination of a locking storage device and one-shot locking logic such that upon initialization, storage is unlocked (i.e. writable), but at some point in the initialization process, the one-shot device is triggered, locking storage until a power cycle occurs.

Locking trigger: the signal which, when applied to the one-shot locking logic, “trips” the circuit, causing storage to be locked (write protected).

### DETAILED DESCRIPTION

Embodiments of the invention relate to updating or replacing a bootloader in a target digital computing device such that only an authorized version may be used, and doing so in a secure manner. While the invention is illustrated using a two-stage bootloader and associated configuration embodied contiguously within a single locking storage device, other configurations are also possible. According to an embodiment of the invention, when the device is powered up, a one-shot storage lock is enabled, allowing writing to a locking storage device used for bootloader storage. The first stage bootloader is executed, and as part of that execution, checks to see if an update to the second stage bootloader is available. If an update is not available, the locking trigger is executed, locking storage, and execution continues with the second stage of the bootloader. If an update to the second stage bootloader is available, the update is verified, and written to the locking storage device. After the write completes, the locking trigger is executed, locking storage, and execution continues, with the updated second stage bootloader.

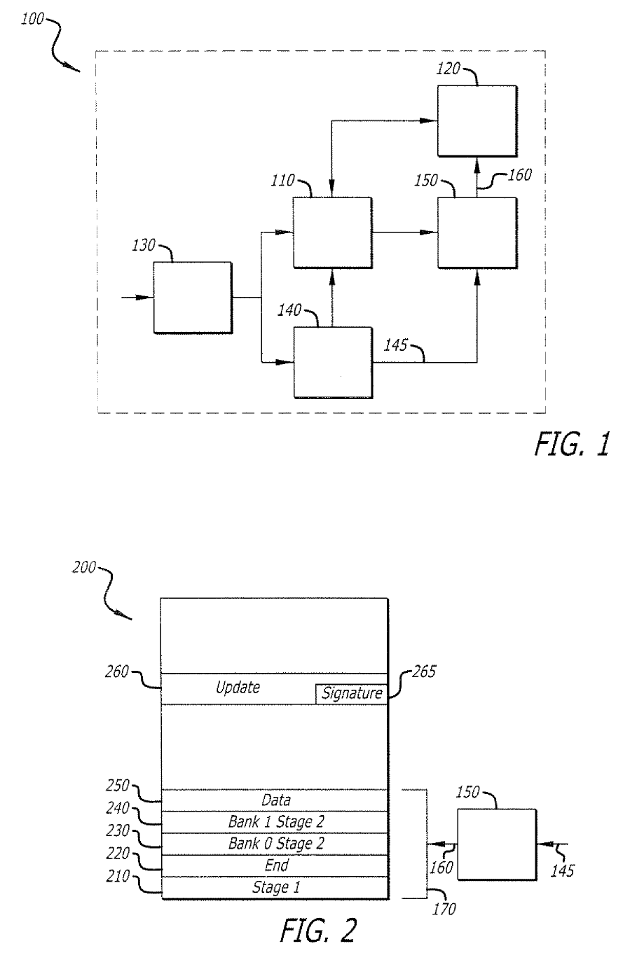

FIG. 1 shows a block diagram of a target device 100 according to an aspect of the invention. Central processing unit (CPU) 110 is connected to memory hierarchy 120, which contains instructions and data. Such memory hierarchy 120 contains a mix of non-volatile memory such as read-only memory (ROM), flash memory, or electrically programmable read-only memory (EEPROM), volatile memory such as RAM, and optionally mass storage such as Flash, compact flash, or disc. CPU 110 is also connected to input-output devices such as network adapters, displays, and the like, not shown for clarity.

Power supply 130 takes power from a source (not shown) such as an AC source, 802.3af Power over Ethernet, a direct current source, or the like, and provides regulated DC voltages to operate target device 100. As is known to the art, while these voltages may be regulated with precision, they may vary during the power-up interval, going from zero to their regulated levels. Therefore a reset generator 140 is provided which monitors one or more regulated voltages from power supply 130, and generates reset signals which do not allow for device operation until the outputs of power supply 130 have stabilized. Suitable reset generators include the MAX811 from Maxim, the ADM709 manufactured by Analog Devices, the PCD1252 family of devices from NXP Semiconductor, and similar components from companies such as National Semiconductor, Linear Technologies, Texas Instruments, and the like.

According to an aspect of the invention, as target device 100 powers up, signaled for example by a reset signal from reset generator 140, one-shot locking logic 150 is set by reset generator 140 producing a write enable signal 160 to the locking storage device portion of memory hierarchy 120. This write enable signal is only provided when target device 100 powers up.

As is known to the art, when CPU 110 is reset, it follows a reset sequence detailed by its manufacturer. As examples, some CPUs start fetching instructions from memory location 0000; other CPUs fetch an address from a predefined memory address, and then begin executing instructions at the memory location thus pointed to. As is known to the art, memory 120 at these addresses must be present at device reset, and is commonly provided by a persistent memory, such as read-only memory (ROM), flash memory, or electrically programmable read-only memory (EEPROM). This first section of instruction code is the stage 1 bootloader.

According to the present invention, and referring to FIG. 2, a portion 170 of non-volatile memory 200 forms a locking storage device. One-shot locking logic 150 write enables 160 this portion on receipt of a power-on reset signal 145. Non-volatile memory may be a Flash memory device, an EEPROM, or a combination of non-volatile memory devices.

As device 100 starts up, the stage 1 loader 210 does the following:

Complete additional processor Initialization, such as initializing RAM, stack pointers, memory maps, interrupts, and the like.

Optionally, initialize a secondary storage device containing the stage 2 loader (if it is not contained in the same storage device 200 as stage 1).

Optionally, transfer a copy of itself into RAM, and continue execution there. This step is often performed if there is a speed difference between fetching and executing instructions from the non-volatile memory containing the stage 1 loader and from RAM.

Test for presence of stage 2 update. This update 260 may be contained in the same storage device 200 as the stage 1 bootloader, or a different persistent storage device. If no update present, execute one-shot locking logic 150, disabling write enable 160, which disables writes to the bootloader storage segment.

One-shot locking logic 150 may be triggered to disable write enable 160, write protecting the bootloader storage segment in many ways, depending on the architecture of the particular device. In a CPU supporting an I/O register architecture, the trigger may be mapped to a particular I/O register, or to a bit in an I/O register. In memory-mapped architectures, the trigger may be mapped to accessing a particular memory location or range of memory locations.

If an update is present:

Validate the update image. This may be done through techniques such as checksums, validating a digital signature 265 attached to the image, validating a cryptographic signature of the image such as a hash, or other cryptographic process.

Examine bank select configuration for stage 2; select the inactive bank 230 240 and write the stage 2 update to that bank 230 240. The active bank may be stored as an environment variable in locking storage 220.

Update the bank select value, making the newly copied stage 2 loader the active bank

Execute one-shot locking logic 150, disabling write enable 160, which disables writes to bootloader storage segment.

Note that regardless of whether the update completes successfully or an error occurs, the one-shot locking logic is executed, write-protecting bootloader storage.

Make any necessary preparations for second stage loading.

If there are multiple copies of the second stage, check the bank select configuration to determine which bank 230 240 is active/valid

Validate the selected second stage image, using a checksum or digital signature

If the active second stage bootloader does not validate, reselect the older second stage bootloader

Optionally load the second stage bootloader into RAM

Transfer control to the second stage bootloader

While this embodiment of the invention provides for a backup copy of the second stage bootloader, an alternate embodiment may use only one storage area 230 for storing the second stage bootloader. In this case, updates to the second stage bootloader are applied in place. Failure of this updated second stage bootloader results in an inoperable device colloquially known as a brick.

As shown in FIG. 2, nonvolatile storage 200 has a portion protected as locking storage. This locked portion may include the stage 1 bootloader 210 and protected environment variables 220, or the memory area 210 used by stage 1 bootloader may be write protected at all times. In other embodiments, locking storage 170 may be present as a separate nonvolatile memory device, or the entire nonvolatile memory 200 may be locked.

As an example, a 64 kbyte nonvolatile storage device such as an EEPROM may be used for nonvolatile storage device 200. The first 16 kbytes may be dedicated to stage 1 bootloader 210 and environmental variables 220. The second 16 kbytes may be dedicated to bank 0 stage 2 bootloader storage 230, the third 16 kbytes dedicated to bank 1 stage 2 bootloader 240, and the final 16 kbytes dedicated to holding update image 260 and signature 265.

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. A locking storage device in a digital computing device, the locking storage comprising:
a nonvolatile memory device for storing at least a second stage bootloader for the digital computing device, and
locking logic connected to the nonvolatile memory device for write protecting at least a portion of the nonvolatile memory device holding the second stage bootloader, the locking logic responsive to a first signal from the digital computing device allowing write access to at least a portion of the nonvolatile memory device, and responsive to a second signal for clearing the write access to the nonvolatile memory device, where the first signal is generated once upon powering up the digital computing device.

2. The locking storage device of claim 1 where a portion of the nonvolatile memory device is protected by the locking logic.

3. The locking storage device of claim 1 where the entire nonvolatile memory device is protected by the locking logic.

4. The locking storage device of claim 1 where the nonvolatile memory device stores at least a first second-stage bootloader and a second second-stage bootloader, and the locking logic write protects at least the first second-stage bootloader and the second second-stage bootloader.

5. A method of using a locking storage device in a digital computing device, the method comprising:
upon powering up the digital device, executing a first stage bootloader stored in nonvolatile memory,
the first stage bootloader checking for the presence of an update to the second stage bootloader stored in the locking storage device, the update stored in a nonvolatile memory device,
validating the update image,
if the update image is successfully validated, copying the update image to the second stage bootloader storage in the locking storage device,
generating the second signal clearing write access to the locking storage device containing the second stage bootloader, and
transferring control to the second stage bootloader.

6. The method of claim 5 where the first stage bootloader and the second stage bootloader are stored in the same nonvolatile memory device.

7. The method of claim 5 where the first stage bootloader, the second stage bootloader, and the update image are stored in the same nonvolatile memory device.

8. The method of claim 5 where the first stage bootloader and the second stage bootloader are stored in the same nonvolatile memory device, the second stage bootloader is stored in locking storage in the nonvolatile memory device, and the first stage bootloader is always write-protected.

9. The method of claim 5 where the first stage bootloader and the second stage bootloader are stored in the same nonvolatile memory device, and both the first stage bootloader and the second stage bootloader are stored in locking storage.
